(19) United States
(12) Patent Application Publication
(10) Pub. No.: US 2026/0127881 A1
(43) Pub. Date: May 7, 2026

(54) METHOD AND COMPUTER PROGRAM FOR DETECTING EVENT BASED ON TEXT PROMPT

(71) Applicant: PIAspace Co., Ltd., Daegu (KR)

(72) Inventors: Heon Su YU, Daegu (KR); Sung Jun LEE, Daegu (KR); Seong Hyeok PARK, Daegu (KR); Yang Ro LEE, Daegu (KR)

(73) Assignee: PIAspace Co., Ltd., Daegu (KR)

(21) Appl. No.: 19/437,299

(22) Filed: Dec. 31, 2025

Related U.S. Application Data
(63) Continuation of application No. PCT/KR2024/016841, filed on Oct. 30, 2024.

(30) Foreign Application Priority Data
Oct. 30, 2023 (KR) 10-2023-0147061
Oct. 29, 2024 (KR) 10-2024-0149988

(51) Int. Cl. G06V 20/40; G06F 3/0482; G06F 3/04847; G06V 10/74; G06V 10/77

(52) U.S. Cl. CPC G06V 20/44; G06F 3/0482; G06F 3/04847; G06V 10/761; G06V 10/7715

(57) ABSTRACT

A method of detecting an event based on a text prompt may include: generating an event vector, which is a vector in a latent space for each of one or more event prompts defined in a natural language; extracting a feature for each of a plurality of sections forming an image; generating, based on each extracted feature, a section vector, which is a vector in the latent space for each of the plurality of sections; generating image analysis data, based on a similarity between the section vector in the latent space for each of the plurality of sections and one or more event vectors; and providing an analysis result of the image, based on the image analysis data.

### CROSS-REFERENCE TO RELATED APPLICATION

The present application is a continuation of International Application of PCT application serial No. PCT/KR2024/016841, filed on Oct. 30, 2024, which claims the priority benefit of Korea application serial no. 10-2023-0147061, filed on Oct. 30, 2023, and Korea application serial no. 10-2024-0149988, filed on Oct. 29, 2024. The entirety of the above-mentioned patent application is hereby incorporated by reference herein and made a part of this specification.

### TECHNICAL FIELD

The present disclosure relates to a method and computer program for detecting an event, based on a text prompt defining event content.

### BACKGROUND

With the development of information and communication technology, artificial intelligence technologies have been introduced to a large number of applications. Artificial intelligence technologies have also been actively employed in image surveillance fields, and thus, operations performed by humans have been replaced by artificial intelligence.

Previously, in order to detect a specific event in an image, a technique was used, in which a manager may monitor the image or detect, based on a rule, a predefined event in the image.

In the case of the technique in which the manager may monitor the image, continuous monitoring by the manager is required, and thus, the degree of fatigue of the manager may increase, and also, a gap in the monitoring may occur according to a condition of the manager, such as the absence of the manager, or the like.

In the case of the rule-based technique, not only is it required to set rules for all situations, but it also is required to set a plurality of rules corresponding to various cases for a single event, and thus, there may be an inconvenience, and accuracy of detecting an event may decrease.

### SUMMARY

A method of detecting an event, based on a text prompt, according to an embodiment of the present disclosure, may include: generating an event vector, which is a vector in a latent space for each of one or more event prompts defined in a natural language; extracting a feature for each of a plurality of sections forming an image; generating, based on each extracted feature, a section vector, which is a vector in the latent space for each of the plurality of sections; generating image analysis data, based on a similarity between the section vector in the latent space for each of the plurality of sections and one or more event vectors; and providing an analysis result of the image, based on the image analysis data.

The generating of the image analysis data may include: determining, based on the similarity between the section vector for each of the plurality of sections and the one or more event vectors, an event intensity of each of one or more events for each of the plurality of sections; generating one or more parent event groups by grouping time points at which the event intensity exceeds a predetermined threshold value; and generating parent event information of the one or more parent event groups, based on content of an event prompt corresponding to each of one or more time points included in a same group for each of the one or more parent event groups and an order of occurrence of the one or more time points.

The providing of the analysis result may include providing an analysis screen including a first area indicating, in time series, event intensities of one or more events for each of the plurality of sections, wherein the event intensity may be calculated based on the similarity between the section vector in the latent space for each of the plurality of sections and the one or more event vectors.

The providing of the analysis result may include providing an analysis screen including a second area indicating, in time series, time points for each of one or more events, by collecting the time points at which an event intensity exceeds a predetermined threshold value for each of the one or more event prompts, wherein the event intensity may be calculated based on the similarity between the section vector in the latent space for each of the plurality of sections and the one or more event vectors.

The providing of the analysis result may include providing an analysis screen including a third area indicating, in time series, events based on time points of occurrence of the events, by collecting time points at which an event intensity exceeds a predetermined threshold value, wherein the event intensity may be calculated based on the similarity between the section vector in the latent space for each of the plurality of sections and the one or more event vectors.

The providing of the analysis result may include: providing an event list displaying one or more event histories; providing, on a fourth area, an event image corresponding to a first event selected from the event list; and providing, on a fifth area, a slider bar configured to indicate a relative position of an individual frame displayed on the fourth area in the event image according to reproduction of the event image and control a displayed frame according to a user input.

The providing of the slider bar may include: providing the slider bar such that a first entity corresponding to at least a portion of the event image is displayed; and providing the slider bar such that one or more thumbnails are displayed on the first entity, wherein a frame at a time point at which an event intensity exceeds a predetermined threshold value may be displayed as the one or more thumbnails, and wherein the event intensity may be calculated based on a similarity between a section vector for each of one or more sections forming the event image and the one or more event vectors.

The providing of the slider bar may further include providing the slider bar such that an entity indicating an event prompt associated with the one or more thumbnails may be displayed in association with the one or more thumbnails.

The providing of the slider bar may further include providing the slider bar such that an entity indicating parent event group information including an event corresponding to each of the one or more thumbnails may be displayed in association with the one or more thumbnails.

The providing of the slider bar may further include: providing the slider bar such that an image at a time point corresponding to a thumbnail according to a user selection of any one of the one or more thumbnails is displayed on the fourth area; and providing the slider bar such that an image at a time point corresponding to a first-appearing event of one or more events included in a parent event group may be displayed on the fourth area according to a user selection of the entity indicating the parent event group information.

According to the present disclosure, an image may be analyzed with human level flexibility and accuracy by defining, as text, an event to be detected and comparing the text with a situation in the image.

Also, according to the present disclosure, when providing an event image, a user may not only have a glance at major events in the event image through a slider bar without having to view the entire image, but the user may also examine events for each of event groups.

### BRIEF DESCRIPTION OF DRAWINGS

FIG. 1 is a schematic diagram of a structure of an image analysis system according to an embodiment of the present disclosure.

FIG. 2 is a schematic diagram of a structure of a server according to an embodiment of the present disclosure.

FIG. 3 is a schematic diagram of a structure of a user terminal according to an embodiment of the present disclosure.

FIG. 4 is a diagram for describing a process in which a server generates a vector from an event prompt and an image, according to an embodiment of the present disclosure.

FIG. 5 is a diagram of an example of a graph indicating image analysis data generated by the server, according to an embodiment of the present disclosure.

FIG. 6 is a diagram of an example of an event group.

FIG. 7 is a diagram of an example of a screen for providing an image analysis result, the screen being displayed on the user terminal.

FIG. 8 is a diagram of an example of a screen for providing an image analysis result, the screen being displayed on the user terminal.

FIG. 9 is a flowchart for describing a method, performed by the server, of detecting an event, based on a text prompt, according to an embodiment of the present disclosure. Hereinafter, FIGS. 1 to 8 will be referred to together for descriptions.

### DESCRIPTION OF EMBODIMENTS

A method of detecting an event, based on a text prompt, according to an embodiment of the present disclosure, may include: generating an event vector, which is a vector in a latent space for each of one or more event prompts defined in a natural language; extracting a feature for each of a plurality of sections forming an image; generating, based on each extracted feature, a section vector, which is a vector in the latent space for each of the plurality of sections; generating image analysis data, based on a similarity between the section vector in the latent space for each of the plurality of sections and one or more event vectors; and providing an analysis result of the image, based on the image analysis data.

Various modifications may be made to the present disclosure, and the present disclosure may have various embodiments, and thus, certain embodiments are shown by way of example in the drawings and will herein be described in detail. The effects and the characteristics of the present disclosure, and methods of realizing the same will become apparent by referring to the drawings and embodiments described in detail below. However, the present disclosure is not limited to the embodiments disclosed below and may be realized in various forms.

Hereinafter, the embodiments of the present disclosure will be described in detail by referring to the accompanying drawings. In descriptions with reference to the drawings, the same reference numerals are given to elements that are the same or substantially the same and descriptions will not be repeated.

In the embodiments hereinafter, terms such as first, second, etc. are used to distinguish one element from another, rather than being used to define meanings. In the embodiments hereinafter, the singular expressions are intended to include the plural forms as well, unless the context clearly indicates otherwise. In the embodiments hereinafter, terms such as includes and/or including specify the presence of features or components stated in the specification, and do not preclude the probable addition of one or more other features or components. In the drawings, sizes of elements may be exaggerated or reduced for convenience of explanation. For example, sizes and shapes of the elements in the drawings are arbitrarily indicated for convenience of explanation, and thus, the present disclosure is not necessarily limited to the illustrations of the drawings.

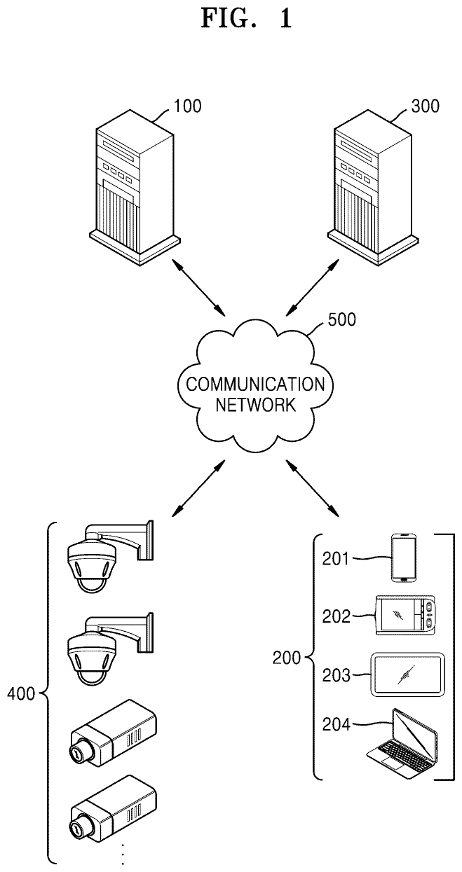

FIG. 1 is a schematic diagram of a structure of an image analysis system according to an embodiment of the present disclosure.

The image analysis system according to an embodiment of the present disclosure may detect an event in an image by using one or more event prompts defined in a natural language. Also, the image analysis system according to an embodiment of the present disclosure may generate image analysis data, based on a similarity between an event prompt and an image in a latent space, and provide the generated image analysis data to a user.

In the present disclosure, a “prompt” may denote an input value that is input by a user for operating a trained artificial neural network (or model). Also, in the present disclosure, an “event prompt” may denote an input value indicating an event to be detected by using a trained artificial neural network (or model). Furthermore, an “event prompt defined in a natural language” may denote an input value indicating an event to be detected by using a trained artificial neural network (or model), the input value being composed in a language which may be understood by a human. For example, the event prompt defined in the natural language may include a sentence written in the natural language to detect a fire and smoke, such as “there is fire and smoke in the building.” However, such a prompt described above is an example, and the concept of the present disclosure is not limited thereto.

In the present disclosure, a “latent space” may denote a space in which latent features of an event prompt and an image are digitized.

The image analysis system according to an embodiment of the present disclosure may include a server 100, a user terminal 200, an image storage device 300, an image obtaining device 400, and a communication network 500, as illustrated in FIG. 1.

The server 100 according to an embodiment of the present disclosure may detect an event in an image by using one or more event prompts defined in a natural language. Also, the server 100 according to an embodiment of the present disclosure may generate image analysis data, based on a similarity between an event prompt and an image in a latent space, and provide the generated image analysis data to a user.

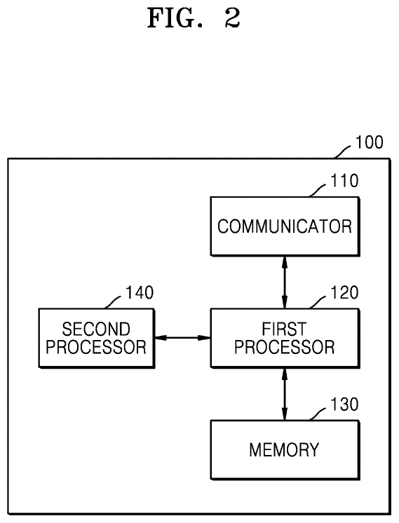

FIG. 2 is a schematic diagram of a structure of the server 100 according to an embodiment of the present disclosure. Referring to FIG. 2, the server 100 according to an embodiment of the present disclosure may include a communicator 110, a first processor 120, memory 130, and a second processor 140. Also, although not shown in the drawing, the server 100 according to an embodiment of the present disclosure may further include an input/output interface, a program storage, etc.

The communicator 110 may include a device including hardware and software needed for the server 100 to transmit and receive signals, such as control signals or data signals, to and from other network devices, such as the user terminal 200 and/or the image storage device 300, through wired or wireless connection.

The first processor 120 may include a device configured to control a series of processes of detecting an event in a received image. For example, the first processor 120 may determine a similarity between a vector corresponding to an event prompt and a vector corresponding to a section of an image in a latent space, and based on the determined similarity, generate image analysis data.

Also, the first processor 120 may include a device configured to control a series of processes of generating output data from input data by using trained artificial neural networks. For example, the first processor 120 may include a device configured to control a process of extracting a feature from an event prompt by using a text model or control a process of extracting a feature from an image by using a vision-language model.

Here, the processor may indicate, for example, a data processing device embedded in hardware and having a circuit physically structuralized to perform a function represented by a code or a command included in a program. Examples of the data processing device embedded in the hardware as described above may include all types of processing devices encompassing a microprocessor, a central processing unit (CPU), a processor core, a multiprocessor, an application-specific integrated circuit (ASIC), a field programmable gate array (FPGA), etc., but the scope of the present disclosure is not limited thereto.

The memory 130 may perform a function of temporarily or permanently storing data processed by the server 100. The memory may include magnetic storage media or flash storage media, but the scope of the present disclosure is not limited thereto. For example, the memory 130 may temporarily and/or permanently store data (for example, coefficients) included in a trained artificial intelligence neural network. However, the memory 130 may also store training data for training an artificial neural network or image data received from the image obtaining device 400. However, this is only an example, and the concept of the present disclosure is not limited thereto.

The second processor 140 may indicate a device configured to perform an operation according to control by the first processor 120. Here, the second processor 140 may include a device having a higher operation capacity than the first processor 120 described above. For example, the second processor 140 may include a graphics processing unit (GPU) and/or a neural processing unit (NPU). However, this is only an example, and the concept of the present disclosure is not limited thereto. According to an embodiment of the present disclosure, the second processor 140 may include a plurality of processors or a single processor.

The user terminal 200 according to an embodiment of the present disclosure may include a device configured to provide an image analysis result provided by the server 100 to a user.

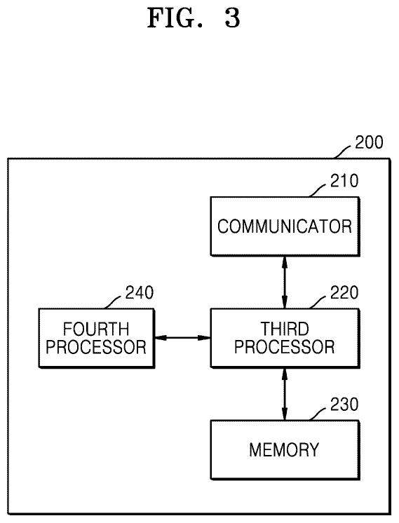

FIG. 3 is a schematic diagram of a structure of the user terminal 200 according to an embodiment of the present disclosure. Referring to FIG. 3, the user terminal 200 according to an embodiment of the present disclosure may include a communicator 210, a third processor 220, memory 230, and a fourth processor 240. Also, although not shown in the drawing, the user terminal 200 according to an embodiment of the present disclosure may further include an input/output interface, a program storage, etc.

The communicator 210 may include a device including hardware and software needed for the user terminal 200 to transmit and receive signals, such as control signals or data signals, to and from other network devices, such as the server 100 and/or the image storage device 300, through wired or wireless connection.

The third processor 220 according to an embodiment of the present disclosure may provide an image analysis result provided by the server 100 to a user. Also, the third processor 220 may transmit a request according to an input of the user to the server 100. For example, the third processor 220 may receive an event list from the server 100 and provide the event list to the user, and the third processor 220 may request, from the server 100, an image corresponding to an event selected from the list by the user.

Here, the processor may indicate, for example, a data processing device embedded in hardware and having a circuit physically structuralized to perform a function represented by a code or a command included in a program. Examples of the data processing device embedded in the hardware as described above may include all types of processing devices encompassing a microprocessor, a CPU, a processor core, a multiprocessor, an ASIC, an FPGA, etc., but the scope of the present disclosure is not limited thereto.

The memory 230 may perform a function of temporarily or permanently storing data processed by the user terminal 200. The memory may include magnetic storage media or flash storage media, but the scope of the present disclosure is not limited thereto. For example, the memory 230 may temporarily and/or permanently store an image received from the server 100. However, this is only an example, and the concept of the present disclosure is not limited thereto.

The fourth processor 240 may indicate a device configured to perform an operation according to control by the third processor 220 described above. Here, the fourth processor 240 may have a higher operation capacity than the third processor 220 described above. For example, the fourth processor 240 may include a GPU and/or an NPU. However, this is only an example, and the concept of the present disclosure is not limited thereto. According to an embodiment of the present disclosure, the fourth processor 240 may include a plurality of processors or a single processor.

The user terminal 200 according to an embodiment of the present disclosure may indicate portable terminals 201, 202, and 203 or a computer 204, as illustrated in FIG. 1.

The user terminal 200 according to an embodiment of the present disclosure may further include a display device for displaying content, etc. to perform the functions described above, and an input device for obtaining an input of a user with respect to the content. Here, the input device and the display device may be variously configured. For example, the input device may include a keyboard, a mouse, a trackball, a microphone, a button, a touch panel, etc., but is not limited thereto.

The image storage device 300 according to an embodiment of the present disclosure may include a device temporarily or permanently storing an image obtained by the image obtaining device 400. Also, the image storage device 300 may include a device configured to provide a stored image in response to a request by another device.

According to another embodiment of the present disclosure, the server 100 described above and the image storage device 300 may be integrally formed as one body. In the other embodiment described above, the server 100 may detect an event in an image and may simultaneously store the image.

The image obtaining device 400 according to an embodiment of the present disclosure may obtain an image with respect to a surveillance object environment or a surveillance target object and transmit the image to another network device. The image obtaining device 400 may be provided in a singular number or a plural number.

The communication network 500 according to an embodiment of the present disclosure may indicate a communication network mediating data transmission and reception between components of the image analysis system. For example, the communication network 500 may encompass wired networks, such as a local area network (LAN), a wide area network (WAN), a metropolitan area network (MAN), an integrated service digital network (ISDN), etc., or wireless networks, such as a wireless LAN, a CDMA, Bluetooth, satellite communication, etc., but the scope of the present disclosure is not limited thereto.

Hereinafter, a process is mainly described, in which the server 100 may detect an event, based on a text prompt.

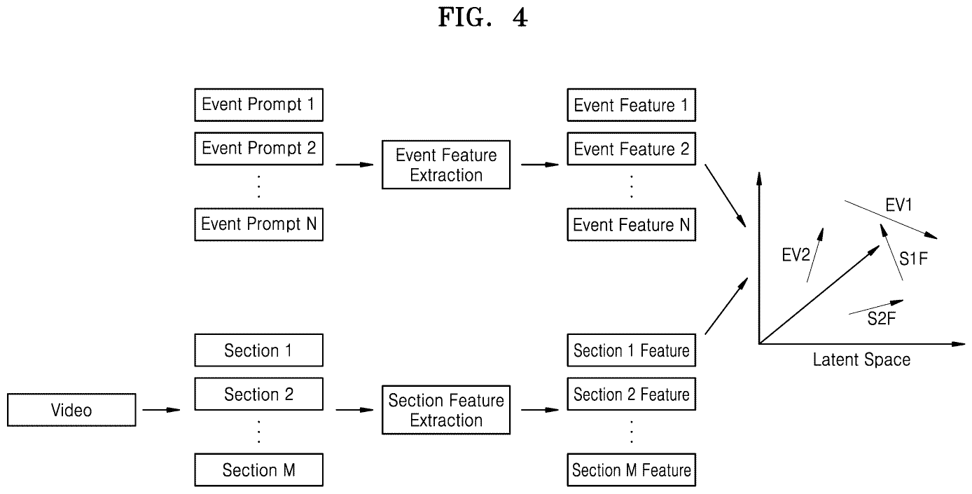

FIG. 4 is a diagram for describing a process in which the server 100 according to an embodiment of the present disclosure may generate a vector from an event prompt and an image.

The server 100 according to an embodiment of the present disclosure may generate an event vector, which is a vector in a latent space for each of one or more event prompts defined in a natural language. In more detail, the server 100 according to an embodiment of the present disclosure may extract a feature from a prompt and generate, based on the extracted feature, the event vector, which is the vector in the latent space. Here, the server 100 according to an embodiment of the present disclosure may extract the feature by using various text models.

For example, the server 100 may extract a first event feature Event Feature 1 from a first event prompt Event Prompt 1 and generate a first event vector EV1 by using the extracted first event feature Event Feature 1. However, the server 100 may generate the event vector for the remaining event prompts by using the same process.

The server 100 according to an embodiment of the present disclosure may generate a section vector for each of a plurality of sections forming an image. In more detail, the server 100 according to an embodiment of the present disclosure may split an image into a plurality of sections, extract a feature for each of the plurality of split sections, and generate, based on each of the extracted features, a section vector, which is a vector in a latent space for each of the plurality of sections. Here, the server 100 according to an embodiment of the present disclosure may extract the feature from the image by using a vision-language model.

For example, the server 100 may generate a first section Section 1 from the image and generate, based on the first section Section 1, a first section feature Section 1 Feature. Also, the server 100 may generate a first section vector S1F by using the first section feature Section 1 Feature. However, the server 100 may generate the section vector for the remaining sections by using the same process.

The server 100 according to an embodiment of the present disclosure may generate image analysis data, based on a similarity between the section vector in the latent space and one or more event vectors.

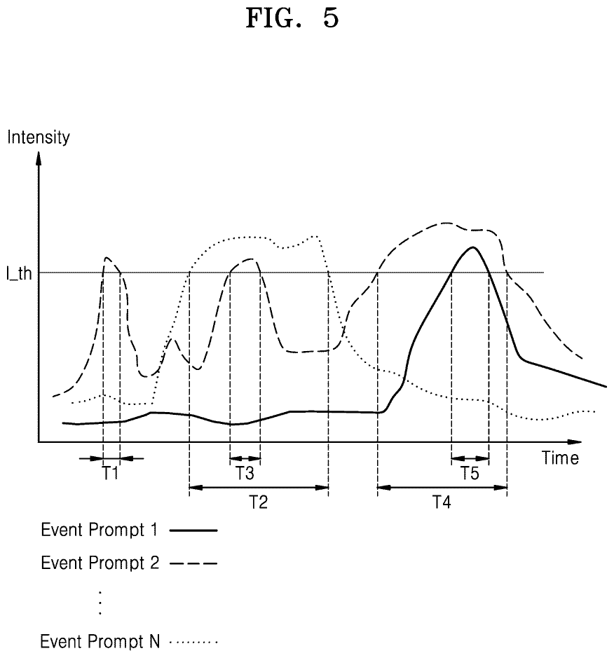

FIG. 5 is a diagram of an example of a graph indicating image analysis data generated by the server 100 according to an embodiment of the present disclosure. In FIG. 5, in a time axis, a plurality of sections are aligned in time series (but the plurality of sections are not separately represented in FIG. 5), and an intensity axis indicates an event intensity at each section.

The server 100 according to an embodiment of the present disclosure may determine an event intensity of each of one or more events for each of the plurality of sections, based on a similarity between a section vector for each of the plurality of sections forming an image and one or more event vectors. For example, as illustrated in FIG. 5, the server 100 may determine each event intensity for each section.

The server 100 according to an embodiment of the present disclosure may identify content and a time point of an event prompt having an event intensity exceeding a predetermined threshold value I_th. For example, the server 100 may identify that the event intensity of the first event prompt Event Prompt 1 exceeds the predetermined threshold value I_th for a section (the time point) T5.

According to a selective embodiment of the present disclosure, the predetermined threshold value may be differently set for each event prompt. For example, the threshold value for the first event prompt Event Prompt 1 and the second event prompt Event Prompt 2 may be differently set by taking into account content, the degree of importance, etc. of the event.

The server 100 according to an embodiment of the present disclosure may generate one or more parent event groups by grouping time points at which the event intensity exceeds a predetermined threshold value. Also, the server 100 according to an embodiment of the present disclosure may generate parent event information of the event group, based on content of an event prompt corresponding to each of one or more time points included in the same group for each of the generated one or more parent event groups and an order of occurrence of the one or more time points.

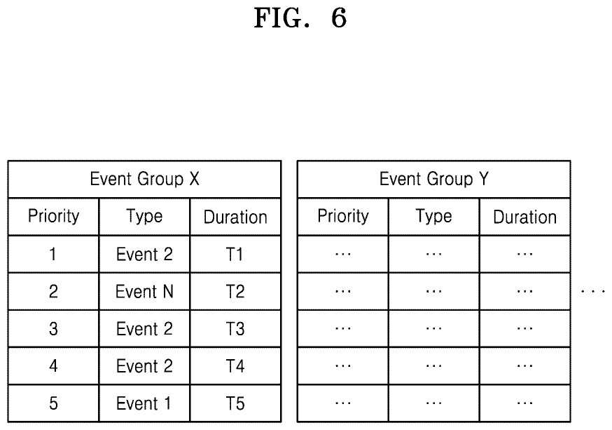

FIG. 6 is a diagram of an example of an event group.

The server 100 according to an embodiment of the present disclosure may generate a parent event group by grouping a series of individual events and generate parent event information based on content, a duration period, and an order of occurrence of each individual event included in the generated parent event group.

For example, the server 100 may group individual events of running Event 2, falling down Event N, running Event 2, running Event 2, and being hurt from a fall Event 1 into one parent event group Event Group X and generate the parent event information of the corresponding group as “chasing.”

As described above, the server 100 according to an embodiment of the present disclosure may derive event information of a parent level, based on the combination of a series of individual events.

The server 100 according to an embodiment of the present disclosure may generate the image analysis data including the event intensity of each of the one or more events for each of the plurality of section, the parent event group, and the parent event content for each parent event group, generated according to the process described above. The generated image analysis data may be provided to the user terminal 200 according to a process described below.

The server 100 according to an embodiment of the present disclosure may provide, based on the image analysis data, an analysis result of the image. For example, the server 100 may transmit the image analysis result to the user terminal 200.

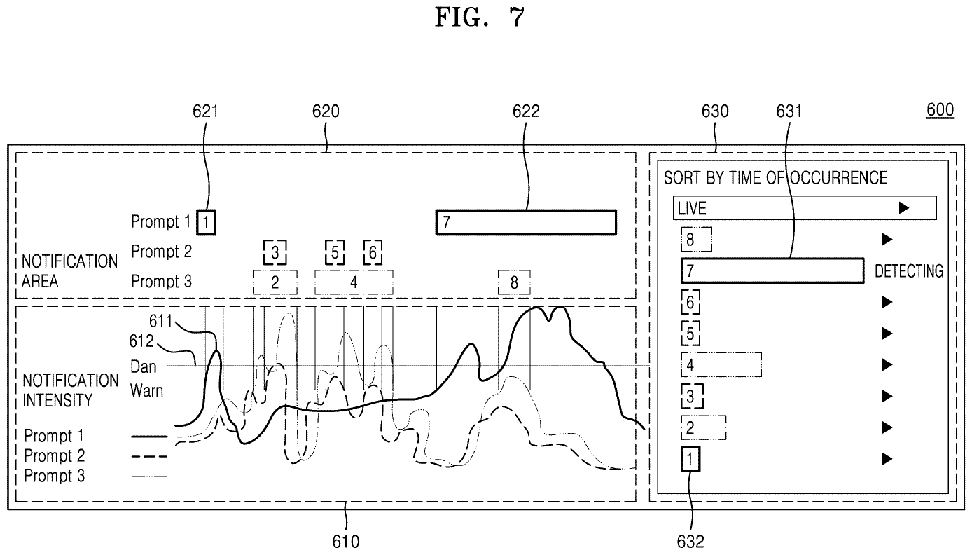

FIG. 7 is a diagram of an example of a screen 600 configured to provide an image analysis result, the screen 600 being displayed on the user terminal 200.

The server 100 according to an embodiment of the present disclosure may provide, through the screen 600 configured to provide the image analysis result, a first area 610 indicating, in time series, event intensities of one or more events for each of a plurality of sections. Here, the event intensity may be calculated based on the similarity between the section vector for each of the plurality of sections and the one or more event vectors as described above. For example, the server 100 may provide, in the form of a graph, an event intensity 611 of a first prompt Prompt 1 over time, that is, at each of the sections, as illustrated in FIG. 7. However, the server 100 may provide the event intensity of the remaining prompts Prompt 2 and Prompt 3 over time in the form of a graph.

The server 100 according to an embodiment of the present disclosure may further provide an entity 612 corresponding to a predetermined reference value based on which occurrence of an event is determined. According to a selective embodiment of the present disclosure, when the occurrence of the event is identified in a plurality of stages, the entity 612 may be provided as a plurality. However, this is only an example, and the concept of the present disclosure is not limited thereto.

The server 100 according to an embodiment of the present disclosure may collect time points at which the event intensity of each of the one or more event prompts exceeds a predetermined threshold value and provide, through the analysis screen 600, a second area 620 indicating, in time series, the time points for each of the one or more events. For example, the server 100 may provide, together with identification information of the first prompt Prompt1, the time points at which the event intensity of the first prompt Prompt 1 exceeds the predetermined threshold value, as entities 621 and 622. Here, however, the event intensity may also be calculated based on the similarity between the section vector for each of the plurality of sections and the one or more event vectors.

The server 100 according to an embodiment of the present disclosure may collect the time points at which the event intensity exceeds the predetermined threshold value and provide, through the analysis screen 600, a third area 630 indicating, in time series, the events based on time points of the occurrence of the events.

For example, the third area 630 may represent the individual events corresponding to the time points displayed on the second area 620, each in the form of the entities corresponding to each time point and event. For example, entities 631 and 632 corresponding to the first prompt Prompt 1 may be represented by being aligned based on the time point of the occurrence of the event. However, this is only an example, and the concept of the present disclosure is not limited thereto.

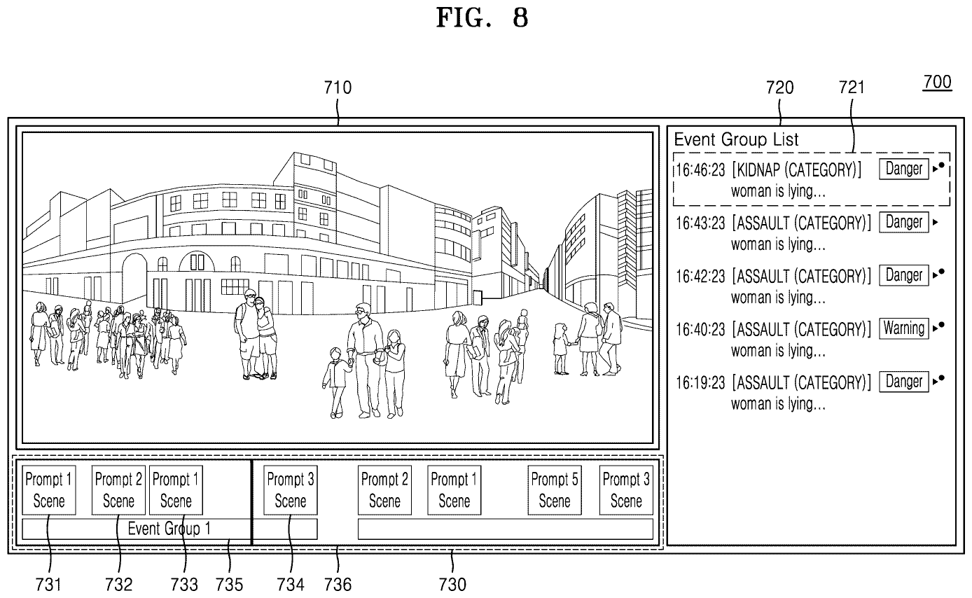

FIG. 8 is a diagram of an example of a screen 700 configured to provide an image analysis result, the screen 700 being displayed on the user terminal 200.

The server 100 according to an embodiment of the present disclosure may provide the screen 700 configured to provide the image analysis result, the screen 700 including an area 710 on which an event image is displayed, an area 720 on which an event list is displayed, and an area 730 on which a slider bar is displayed, as in the screen 700.

The server 100 according to an embodiment of the present disclosure may provide, through the area 720, the event list displaying one or more event histories. For example, the server 100 according to an embodiment of the present disclosure may provide the parent event groups generated by the process described with reference to FIG. 6 as the list.

The server 100 according to an embodiment of the present disclosure may provide, on the area 710, the event image corresponding to a first event selected from the event list displayed on the area 720. Also, the server 100 may provide, on the area 730, the slider bar configured to indicate a relative position of an individual frame provided on the area 710 in the event image according to reproduction of the event image, and control the displayed frame according to a user input. For example, when a user selects a first event 721 in the list, the server 100 may provide, on the area 710, an event image corresponding to the first event 721 and provide, on the area 730, the slider bar configured to control the event image.

The server 100 according to an embodiment of the present disclosure may provide the slider bar such that a first entity 736 corresponding to at least a portion of the event image is displayed. Also, the server 100 may provide the slider bar such that one or more thumbnails 731, 732, 733, and 734 are displayed on the first entity 736. Here, the server 100 may provide the slider bar such that a frame at a time point at which an event intensity exceeds a predetermined threshold value is displayed as the one or more thumbnails 731, 732, 733, and 734.

The server 100 according to an embodiment of the present disclosure may provide the slider bar such that an entity indicating an event prompt associated with the one or more thumbnails 731, 732, 733, and 734 is displayed in association with the one or more thumbnails. For example, the server 100 may display a text entity such as “Prompt 1 Scene” in association with (for example, in an overlapping fashion with) the first thumbnail 731.

Also, the server 100 according to an embodiment of the present disclosure may provide the slider bar such that an entity 735 indicating parent event group information including an event corresponding to each of the one or more thumbnails 731, 732, 733, and 734 is displayed in association with the one or more thumbnails 731, 732, 733, and 734. For example, with respect to an event group Event Group 1, the server 100 may provide, on the slider bar, the one or more thumbnails 731, 732, 733, and 734 and the entity 735 indicating the parent event group information, in a one-to-one correspondence manner, as illustrated in FIG. 8.

However, the display method described above is an example, and display methods, which may be used to display the association between and the one or more thumbnails 731, 732, 733, and 734 and the entity 735 indicating the parent event group information, are not limited.

Text on the entity 735 indicating the parent event group information may correspond to text indicating content of corresponding parent events. For example, when the one or more thumbnails 731, 732, 733, and 734 relate to running, running, falling down, and being hurt from a fall, respectively, the text on the entity 735 indicating the parent event group information may be “chasing,” which is a parent concept of the events. However, this is only an example, and the concept of the present disclosure is not limited thereto.

The server 100 according to an embodiment of the present disclosure may display, on the area 710, an image at a time point corresponding to a thumbnail according to a user selection of any one of the one or more thumbnails 731, 732, 733, and 734. Also, the server 100 according to an embodiment of the present disclosure may display, on the area 710, an image at a time point corresponding to a first event from among one or more events included in the parent event group, according to a user selection of the entity 735 indicating the parent event group information.

According to a selective embodiment, according to the user selection of the entity 735 indicating the parent event group information, only the one or more thumbnails 731, 732, 733, and 734 may be sequentially displayed on the area 710 according to time. Here, each of the one or more thumbnails 731, 732, 733, and 734 may be a frame at the time point at which the event intensity exceeds the predetermined threshold value as described above.

Therefore, according to the present disclosure, an event image may be provided such that not only a user may be able to have a glance of major events in the event image through a slider bar, without having to view the entire image, but the user may also examine an event for each event group.

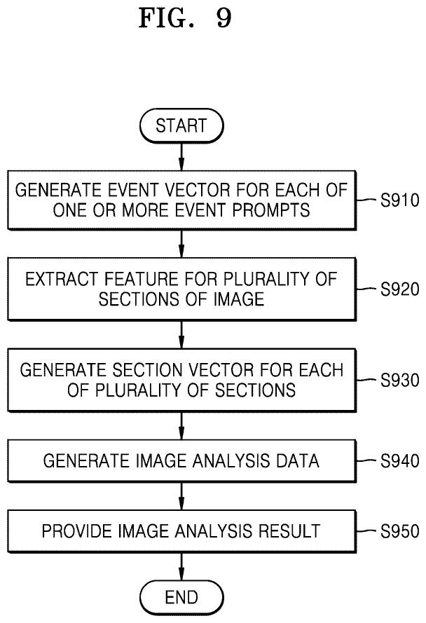

FIG. 9 is a flowchart for describing a method, performed by the server 100, of detecting an event, based on a text prompt, according to an embodiment of the present disclosure. Hereinafter, descriptions will be given by referring to FIGS. 1 to 8 together.

The server 100 according to an embodiment of the present disclosure may generate an event vector, which is a vector in a latent space for each of one or more event prompts defined in a natural language in operation S910.

FIG. 4 is a diagram for describing a process in which the server 100 according to an embodiment of the present disclosure may generate a vector from an event prompt and an image.

The server 100 according to an embodiment of the present disclosure may extract a feature from a prompt and generate, based on the extracted feature, the event vector, which is the vector in the latent space. Here, the server 100 according to an embodiment of the present disclosure may extract the feature by using various text models.

For example, the server 100 may extract a first event feature Event Feature 1 from a first event prompt Event Prompt 1 and generate a first event vector EV1 by using the extracted first event feature Event Feature 1. However, the server 100 may generate the event vector for the remaining event prompts by using the same process.

The server 100 according to an embodiment of the present disclosure may generate a section vector for each of a plurality of sections forming an image.

In more detail, the server 100 according to an embodiment of the present disclosure may split an image into a plurality of sections, extract a feature for each of the plurality of split sections, and generate, based on each of the extracted features, a section vector, which is a vector in a latent space for each of the plurality of sections in operation S930. Here, the server 100 according to an embodiment of the present disclosure may extract the feature from the image by using a vision-language model.

For example, the server 100 may generate a first section Section 1 from the image and generate, based on the first section Section 1, a first section feature Section 1 Feature. Also, the server 100 may generate a first section vector S1F by using the first section feature Section 1 Feature. However, the server 100 may generate the section vector for the remaining sections by using the same process.

The server 100 according to an embodiment of the present disclosure may generate image analysis data, based on a similarity between the section vector in the latent space and one or more event vectors in operation S940.

FIG. 5 is a diagram of an example of a graph indicating image analysis data generated by the server 100 according to an embodiment of the present disclosure. In FIG. 5, in a time axis, a plurality of sections are aligned in time series (but the plurality of sections are not separately represented in FIG. 5), and an intensity axis indicates an event intensity at each section.

The server 100 according to an embodiment of the present disclosure may determine an event intensity of each of one or more events for each of the plurality of sections, based on a similarity between a section vector for each of the plurality of sections forming an image and the one or more event vectors. For example, as illustrated in FIG. 5, the server 100 may determine each event intensity for each section.

The server 100 according to an embodiment of the present disclosure may identify content and a time point of an event prompt having an event intensity exceeding a predetermined threshold value I_th. For example, the server 100 may identify that the event intensity of the first event prompt Event Prompt 1 exceeds the predetermined threshold value I_th for a section (the time point) T5.

According to a selective embodiment of the present disclosure, the predetermined threshold value may be differently set for each event prompt. For example, the threshold value for the first event prompt Event Prompt 1 and the second event prompt Event Prompt 2 may be differently set by taking into account content, the degree of importance, etc. of the event.

The server 100 according to an embodiment of the present disclosure may generate one or more parent event groups by grouping time points at which the event intensity exceeds a predetermined threshold value. Also, the server 100 according to an embodiment of the present disclosure may generate parent event information of the event group, based on content of an event prompt corresponding to each of one or more time points included in the same group for each of the generated one or more parent event groups and an order of occurrence of the one or more time points.

FIG. 6 is a diagram of an example of an event group.

The server 100 according to an embodiment of the present disclosure may generate a parent event group by grouping a series of individual events and generate parent event information based on content, a duration period, and an order of occurrence of each individual event included in the generated parent event group.

For example, the server 100 may group individual events of running Event 2, falling down Event N, running Event 2, running Event 2, and being hurt from a fall Event 1 into one parent event group Event Group X and generate the parent event information of the corresponding group as “chasing.”

As described above, the server 100 according to an embodiment of the present disclosure may deduce event information of a parent level, based on the combination of a series of individual events.

The server 100 according to an embodiment of the present disclosure may generate the image analysis data including the event intensity of each of the one or more events for each of the plurality of section, the parent event group, and the parent event content for each parent event group, generated according to the process described above. The generated image analysis data may be provided to the user terminal 200 according to a process described below.

The server 100 according to an embodiment of the present disclosure may provide an image analysis result based on the image analysis data in operation S950. For example, the server 100 may transmit the image analysis result to the user terminal 200.

FIG. 7 is a diagram of an example of a screen 600 configured to provide an image analysis result, the screen 600 being displayed on the user terminal 200.

The server 100 according to an embodiment of the present disclosure may provide, through the analysis screen 600, a first area 610 indicating, in time series, event intensities of one or more events for each of a plurality of sections. Here, the event intensity may be calculated based on the similarity between the section vector for each of the plurality of sections and the one or more event vectors as described above. For example, the server 100 may provide, in the form of a graph, an event intensity 611 of a first prompt Prompt 1 over time, that is, at each of the sections, as illustrated in FIG. 7. However, the server 100 may provide the event intensity of the remaining prompts Prompt 2 and Prompt 3 over time in the form of a graph.

The server 100 according to an embodiment of the present disclosure may further provide an entity 612 corresponding to a predetermined reference value based on which occurrence of an event is determined. According to a selective embodiment of the present disclosure, when the occurrence of the event is identified in a plurality of stages, the entity 612 may be provided as a plurality. However, this is only an example, and the concept of the present disclosure is not limited thereto.

The server 100 according to an embodiment of the present disclosure may collect time points at which the event intensity of each of the one or more event prompts exceeds a predetermined threshold value and provide, through the analysis screen 600, a second area 620 indicating, in time series, the time points for each of the one or more events. For example, the server 100 may provide, together with identification information of the first prompt Prompt1, the time points at which the event intensity of the first prompt Prompt 1 exceeds the predetermined threshold value, as entities 621 and 622. Here, however, the event intensity may also be calculated based on the similarity between the section vector for each of the plurality of sections and the one or more event vectors.

The server 100 according to an embodiment of the present disclosure may collect the time points at which the event intensity exceeds the predetermined threshold value and provide, through the analysis screen 600, a third area 630 indicating, in time series, the events based on time points of the occurrence of the events.

For example, the third area 630 may represent the individual events corresponding to the time points displayed on the second area 620, each in the form of the entities corresponding to each time point and event. For example, entities 631 and 632 corresponding to the first prompt Prompt 1 may be represented by being aligned based on the time point of the occurrence of the event. However, this is only an example, and the concept of the present disclosure is not limited thereto.

FIG. 8 is a diagram of an example of a screen 700 configured to provide an image analysis result, the screen 700 being displayed on the user terminal 200.

The server 100 according to an embodiment of the present disclosure may provide the screen 700 configured to provide the image analysis result, the screen 700 including an area 710 on which an event image is displayed, an area 720 on which an event list is displayed, and an area 730 on which a slider bar is displayed, as in the screen 700.

The server 100 according to an embodiment of the present disclosure may provide, through the area 720, the event list displaying one or more event histories. For example, the server 100 according to an embodiment of the present disclosure may provide the parent event groups generated by the process described with reference to FIG. 6 as the list.

The server 100 according to an embodiment of the present disclosure may provide, on the area 710, the event image corresponding to a first event selected from the event list displayed on the area 720. Also, the server 100 may provide, on the area 730, the slider bar configured to indicate a relative position of an individual frame provided on the area 710 in the event image according to reproduction of the event image, and control the displayed frame according to a user input. For example, when a user selects a first event 721 in the list, the server 100 may provide, on the area 710, an event image corresponding to the first event 721 and provide, on the area 730, the slider bar configured to control the event image.

The server 100 according to an embodiment of the present disclosure may provide the slider bar such that a first entity 736 corresponding to at least a portion of the event image is displayed. Also, the server 100 may provide the slider bar such that one or more thumbnails 731, 732, 733, and 734 are displayed on the first entity 736. Here, the server 100 may provide the slider bar such that a frame at a time point at which an event intensity exceeds a predetermined threshold value is displayed as the one or more thumbnails 731, 732, 733, and 734.

The server 100 according to an embodiment of the present disclosure may provide the slider bar such that an entity indicating an event prompt associated with the one or more thumbnails 731, 732, 733, and 734 is displayed in association with the one or more thumbnails. For example, the server 100 may display a text entity such as “Prompt 1 Scene” in association with (for example, in an overlapping fashion with) the first thumbnail 731.

Also, the server 100 according to an embodiment of the present disclosure may provide the slider bar such that an entity 735 indicating parent event group information including an event corresponding to each of the one or more thumbnails 731, 732, 733, and 734 is displayed in association with the one or more thumbnails 731, 732, 733, and 734. For example, with respect to an event group Event Group 1, the server 100 may provide, on the slider bar, the one or more thumbnails 731, 732, 733, and 734 and the entity 735 indicating the parent event group information, in a one-to-one correspondence manner, as illustrated in FIG. 8.

However, the display method described above is an example, and display methods, which may be used to display the association between and the one or more thumbnails 731, 732, 733, and 734 and the entity 735 indicating the parent event group information, are not limited.

Text on the entity 735 indicating the parent event group information may correspond to text indicating content of corresponding parent events. For example, when the one or more thumbnails 731, 732, 733, and 734 relate to running, running, falling down, and being hurt from a fall, respectively, the text on the entity 735 indicating the parent event group information may be “chasing,” which is a parent concept of the events. However, this is only an example, and the concept of the present disclosure is not limited thereto.

The server 100 according to an embodiment of the present disclosure may display, on the area 710, an image at a time point corresponding to a thumbnail according to a user selection of any one of the one or more thumbnails 731, 732, 733, and 734. Also, the server 100 according to an embodiment of the present disclosure may display, on the area 710, an image at a time point corresponding to a first event from among one or more events included in the parent event group, according to a user selection of the entity 735 indicating the parent event group information.

According to a selective embodiment, according to the user selection of the entity 735 indicating the parent event group information, only the one or more thumbnails 731, 732, 733, and 734 may be sequentially displayed on the area 710 according to time. Here, each of the one or more thumbnails 731, 732, 733, and 734 may be a frame at the time point at which the event intensity exceeds the predetermined threshold value as described above.

Therefore, according to the present disclosure, an event image may be provided such that a user may not only be able to have a glance at major events in the event image through a slider bar without having to view the entire image, but the user may also examine an event for each event group.

The embodiment according to the present disclosure as described above may be implemented as a computer program executable by various components on a computer, and this computer program may be recorded on a computer-readable medium. Here, the medium may store a program executable on a computer. Here, examples of the media may include a magnetic medium, such as a hard disk, a floppy disk, and a magnetic tape, an optical recording medium, such as compact disk (CD)-read-only memory (ROM) and digital versatile disk (DVD), a magneto-optical medium, such as a floptical disk, and a device configured to store a program command, such as ROM, random-access memory (RAM), and flash memory.

The computer program may be specially designed and configured for the present disclosure or may be well-known to and usable by one of ordinary skill in the field of computer software. Examples of the computer program include advanced language codes that may be executed by a computer by using an interpreter or the like as well as machine language codes made by a compiler.

Particular executions described in the present disclosure are according to embodiments and do not limit the scope of the present disclosure by any means. For the brevity of the specification, descriptions of electronic components, control systems, software, and other functional aspects of the systems according to the related art may be omitted. Also, the connecting lines, or connectors shown in the various figures presented are intended to represent exemplary functional relationships and/or physical or logical couplings between the various elements. It should be noted that many alternative or additional functional relationships, physical connections or logical connections may be present in a practical device. Also, unless the terms “essential,” “important,” etc. are specifically mentioned, the elements may not be necessarily required for implementation of the present disclosure.

Therefore, the scope of the present disclosure shall not be defined as being limited to the embodiments described above, and the scope of the claims of the patent described below as well as all scopes equivalent to or equivalently modified from the scope of the claims of the patent shall be included in the range of the concept of the present disclosure.

What is claimed is:

1. A method of detecting an event, based on a text prompt, the method comprising:
generating an event vector, which is a vector in a latent space for each of one or more event prompts defined in a natural language;
extracting a feature for each of a plurality of sections forming an image;
generating, based on each extracted feature, a section vector, which is a vector in the latent space for each of the plurality of sections;
generating image analysis data, based on a similarity between the section vector in the latent space for each of the plurality of sections and one or more event vectors; and
providing an analysis result of the image, based on the image analysis data.

2. The method of claim 1, wherein the generating of the image analysis data comprises:
determining, based on the similarity between the section vector for each of the plurality of sections and the one or more event vectors, an event intensity of each of one or more events for each of the plurality of sections;
generating one or more parent event groups by grouping time points at which the event intensity exceeds a predetermined threshold value; and
generating parent event information of the one or more parent event groups, based on content of an event prompt corresponding to each of one or more time points included in a same group for each of the one or more parent event groups and an order of occurrence of the one or more time points.

3. The method of claim 1, wherein the providing of the analysis result comprises providing an analysis screen comprising a first area indicating, in time series, event intensities of one or more events for each of the plurality of sections, and wherein the event intensity is calculated based on the similarity between the section vector in the latent space for each of the plurality of sections and the one or more event vectors.

4. The method of claim 1, wherein the providing of the analysis result comprises providing an analysis screen comprising a second area indicating, in time series, time points for each of one or more events, by collecting the time points at which an event intensity exceeds a predetermined threshold value for each of the one or more event prompts, wherein the event intensity is calculated based on the similarity between the section vector in the latent space for each of the plurality of sections and the one or more event vectors.

5. The method of claim 1, wherein the providing of the analysis result comprises providing an analysis screen comprising a third area indicating, in time series, events based on time points of occurrence of the events, by collecting time points at which an event intensity exceeds a predetermined threshold value, wherein the event intensity is calculated based on the similarity between the section vector in the latent space for each of the plurality of sections and the one or more event vectors.

6. The method of claim 1, wherein the providing of the analysis result comprises:
providing an event list displaying one or more event histories;
providing, on a fourth area, an event image corresponding to a first event selected from the event list; and
providing, on a fifth area, a slider bar configured to indicate a relative position of an individual frame displayed on the fourth area in the event image according to reproduction of the event image and control a displayed frame according to a user input,
wherein the providing of the slider bar comprises:
providing the slider bar such that a first entity corresponding to at least a portion of the event image is displayed; and
providing the slider bar such that one or more thumbnails are displayed on the first entity, wherein a frame at a time point at which an event intensity exceeds a predetermined threshold value is displayed as the one or more thumbnails, and
wherein the event intensity is calculated based on a similarity between a section vector for each of one or more sections forming the event image and the one or more event vectors.

7. The method of claim 6, wherein the providing of the slider bar further comprises providing the slider bar such that an entity indicating an event prompt associated with the one or more thumbnails is displayed in association with the one or more thumbnails.

8. The method of claim 6, wherein the providing of the slider bar further comprises providing the slider bar such that an entity indicating parent event group information comprising an event corresponding to each of the one or more thumbnails is displayed in association with the one or more thumbnails.

9. The method of claim 8, wherein the providing of the slider bar further comprises:
providing the slider bar such that an image at a time point corresponding to a thumbnail according to a user selection of any one of the one or more thumbnails is displayed on the fourth area; and
providing the slider bar such that an image at a time point corresponding to a first-appearing event of one or more events included in a parent event group is displayed on the fourth area according to a user selection of the entity indicating the parent event group information.

10. A non-transitory computer-readable medium storing instructions that, when executed by one or more processors, cause the one or more processors to perform operations for detecting an event, based on a text prompt, the method comprising:
generating an event vector, which is a vector in a latent space for each of one or more event prompts defined in a natural language;
extracting a feature for each of a plurality of sections forming an image;
generating, based on each extracted feature, a section vector, which is a vector in the latent space for each of the plurality of sections;
generating image analysis data, based on a similarity between the section vector in the latent space for each of the plurality of sections and one or more event vectors; and
providing an analysis result of the image, based on the image analysis data.
